(19) United States
(12) Patent Application Publication
(10) Pub. No.: US 2023/0103684 A1
(43) Pub. Date: Apr. 6, 2023

(54) NICKEL-FREE LPG MARINE STEEL PLATE AND MANUFACTURING METHOD THEREFOR

(71) Applicant: NANJING IRON & STEEL CO., LTD., Nanjing (CN)

(72) Inventors: Yantang CHEN, Nanjing (CN); Donghui LI, Nanjing (CN); Dongming DUAN, Nanjing (CN)

(21) Appl. No.: 17/914,350

(22) PCT Filed: May 20, 2020
(86) PCT No.: PCT/CN2020/091126

§ 371 Date: Sep. 25, 2022

(30) Foreign Application Priority Data
Mar. 30, 2020 (CN) 202010240012.7

(51) Int. Cl. C21D 9/00; C22C 38/12; C22C 38/04; C22C 38/00; C22C 38/02; C22C 33/04; C21D 8/02; C21D 1/18

(52) U.S. Cl. CPC C21D 9/0081; C22C 38/12; C22C 38/04; C22C 38/005; C22C 38/02; C22C 38/002; C22C 33/04; C21D 8/0205; C21D 8/0226; C21D 8/0263; C21D 1/18; C21D 2211/001

(57) ABSTRACT

A nickel-free LPG marine steel plate and a manufacturing method therefor belong to the technical field of high-strength structural steels; the steel plate consists of the following chemical components by mass percentage: 0.18 to 0.24% of C, 0.10 to 0.19% of Si, 16.1 to 18.9% of Mn, less than or equal to 0.012% of P, 0.15 to 0.35% of Mo, 0.10 to 0.25% of RE, and the balance of Fe and inevitable impurities; the steel plate has a yield strength of ≥410 MPa and an impact absorption work of ≥66 J at 150° C., has good low-temperature mechanical properties, can replace 5Ni and 9Ni-based steel, and is used for constructing an LPG storage tank and a relevant structural member at low costs.

### TECHNICAL FIELD

The present disclosure belongs to the technical field of high-strength structural steel, and particularly relates to a nickel-free LPG marine steel plate and a manufacturing method therefor.

### BACKGROUND ART

As an ocean energy exploitation technology is gradually mature, the usage amount of liquefied petroleum gas (LPG) is larger and larger, and the application range is wider and wider. Storage and transportation of the liquid energy require steel materials with an excellent low-temperature mechanical property, especially low-temperature toughness, to construct storage tanks, such that it is guaranteed that the storage tanks do not suffer from embrittlement cracking in a low-temperature use environment and run safely.

Conventional storage tank steel for low-temperature energy is usually constructed by using 9Ni series steel, and an alloy element Ni belongs to a scarce resource, such that the production cost is high.

However, existing Ni-free low-temperature steel also has different defects, for example, disclosed in the invention with the application number of CN89104759. X is iron-manganese-aluminum-carbon austenite non-magnetic steel and low-temperature steel, a content of Al in the steel type involved in the technology is as high as 2.3-3.2%, Al₂O₃ molten steel is prone to be generated by means of oxidization and is high in viscosity and poor in fluidity, the production difficulty is increased, the quality of a cast billet and the surface quality of a steel plate are both difficult to guarantee, and a yield is low.

Disclosed in the invention with the application number of 201710865933.0 are a high manganese steel plate for an ultralow temperature environment and a production method therefor, and the technology has the defects that 0.2-1.2% of Cu is added into steel, and an alloy element Ni for inhibiting Cu-induced thermal cracking is not added, such that Cu-induced thermal cracking is formed in a batch production process, a yield is reduced, and the production cost is increased.

Disclosed in the invention with the application number of 201710971086.6 are a low-yield-ratio high-toughness high-manganese steel plate and a production method therefor, 3.0-4.0% of Cr is added into steel involved in the technology, Cr belongs to an element easy to form carbides, if the adding amount is high, multiple types of carbides are easy to form in a production process and are located at the positions of a grain boundary, the performance of an intermediate product and a finished product is deteriorated, and in particular, low-temperature toughness is sharply reduced.

Therefore, invention of an LPG marine steel plate, which has low cost and an excellent low-temperature mechanical property, especially low-temperature toughness, is necessary.

### SUMMARY

Invention objective: In order to overcome the defects in the prior art, the present disclosure provides a nickel-free LPG marine steel plate, and the steel plate has a good low-temperature mechanical property and may replace 5Ni and 9Ni series steel to be used for constructing liquefied petroleum gas (LPG) storage tanks and related structural parts at low cost.

Another objective of the present disclosure is to provide a manufacturing method for the nickel-free LPG marine steel plate. The method is suitable for large-scale industrial production.

Technical solution: The nickel-free LPG marine steel plate in the present disclosure includes the following chemical components in percentage by mass: C: 0.18-0.24%, Si: 0.10-0.19%, Mn: 16.1-18.9%, P: ≤0.012%, Mo: 0.15-0.35%, RE: 0.10-0.25%, and the balance Fe and inevitable impurities.

A metallographic structure of the steel plate is a single-phase austenite structure.

Specifically, the principle of alloying elements mainly controlled by the steel plate is illustrated as follows:

C (carbon): a proper amount of an alloy element C is added to be dissolved in Fe, such that the strength of steel may be improved, the yield strength of the present disclosure is ≥410 MPa, if a content of C is lower than 0.18%, a strengthening effect is insufficient, and the yield strength is difficult to reach an expectation; and if the content of C is higher than 0.24%, more carbides are easily generated on the grain boundary, the performance of the steel is deteriorated, especially low-temperature toughness, consequently, a brittle transition temperature rises, embrittlement cracking occurs, and therefore, the content of C is set within the range of 0.18-0.24 wt. %.

Mn (manganese): an alloy element Mn in the steel expands an austenite area, even an austenite structure may be stabilized to −150° C. without phase change, austenite with a face-centered cubic structure is greater than ferrite with a body-centered cubic structure and has good fracture toughness, if a content of Mn added in the steel is lower than 16.1%, it is insufficient to form a single-phase austenite structure, phase change may occur, resulting in volume change, and the steel is not suitable for manufacturing ultralow-temperature steel structural parts; and if the content of Mn is higher than 18.9%, more carbides (Fe, Mn)₃C, oxides such as MnO, etc. are easily produced at the grain boundary, and the low-temperature toughness of the steel is reduced, such that the content of Mn is set within the range of 16.1-18.9 wt. %, and is preferably selected within the range of 17.1-18.9 wt. %.

P (phosphorus): P belongs to a harmful element in high-strength structural steel, Fe+Fe₃P and Fe+Fe₃C Fe₃P eutectic products are easily formed, the toughness of the steel is sharply reduced, P is limited to be P≤0.012 wt. %, and a harmful effect of P may be remarkably reduced.

Si (silicon): Si in the present disclosure is mainly added for the purpose of deoxidation, a content of Si is not suitable to be too high, if the content is higher than 0.19%, P and C segregation is obviously promoted, the carbide amount at the grain boundary is increased, the eutectic crystal amount of Fe+Fe₃P and Fe+Fe₃C Fe₃P is increased, and the cracking tendency is increased. However, a certain content of Si may increase the yield strength of the steel, such that the content of Si in the steel is set within the range of 0.10-0.19 wt. %.

Mo (molybdenum): by adding a proper amount of Mo, austenite dendrite growth may be improved, carbide precipitation and pearlite formation may be inhibited, network carbides may be reduced, and a good mechanical property may be obtained. If a content of Mo is lower than 0.15%, an effect of inhibiting network carbides is not obvious; and Mo belongs to an expensive alloy element, and the production cost is increased if the content is higher than 0.35%. Therefore, the content of the alloying element Mo of the present disclosure is set within the range of 0.15-0.35 wt. %, and is preferably selected within the range of 0.25-0.35 wt. %.

A rare earth (RE) element: a proper amount of a RE element is added, on one hand, the fluidity of the steel may be remarkably improved, the as-cast structure and grains are refined, the number of carbides at the grain boundary is reduced, formation of intragranular carbides is promoted, and the production process performance is improved. However, the low-temperature toughness is reduced due to excessive addition of RE, such that the content of RE is set within the range of 0.10-0.25 wt. %.

Corresponding to the nickel-free LPG marine steel plate, the technical solution employed by the manufacturing method provided by the present disclosure includes processes of electric furnace smelting, vacuum degassing (VD) furnace refining, die casting, rolling, cooling after rolling and tempering,

where in the rolling process, a 160 mm*1000 mm*2200 mm die casting plate billet is immediately rolled after being uniformly heated and discharged from a furnace, an initial rolling temperature≥1100° C., and a finishing temperature≥980° C.;

in the process of cooling after rolling, the steel plate is rapidly cooled to a room temperature by means of watering; and

in the tempering process, the steel plate is tempered at 280-320° C., and heat preservation is conducted for 80-120 min.

Specifically, in the electric furnace smelting process, alloys including CaO, scrap steel, MnFe, SiFe and MoFe are charged for electrifying and melting, FeO is added for removing P, and the content of alloy elements is adjusted to be a target value.

In the VD furnace refining process, gas elements including 0, N and H are removed in vacuum.

In the die casting process, rare earth wires are fed in the pouring process, and the content of a rare earth element reaches a target value.

Beneficial effects: Compared with the prior art, the chemical components of the steel plate have no Ni element, the component design is simple, and the production cost is remarkably reduced. During manufacturing, the rolling temperature ensures that finished product rolling may be completed in a high-temperature and good-plasticity temperature range, the finished product is rapidly cooled to a room temperature, a single-phase austenite structure is obtained, and then tempering is conducted at 280-320° C. to eliminate residual stress. The finally obtained steel plate has a yield strength≥410 MPa and −150° CKV₂≥66J, and has an excellent comprehensive mechanical property, excellent machining performance and excellent welding performance, and the quality and a comprehensive mechanical property of a welded joint are good; and the use safety of constructed ultralow-temperature environment steel structural parts may be effectively guaranteed. In addition, in the manufacturing method, a fixed-length plate billet is directly die-cast after being smelted on an electric furnace, rolling is continuously completed at a time, intermediate temperature holding is not needed, the production efficiency is high, a yield is high, economic benefits are good, and the method is suitable for large-scale industrial production.

### DETAILED DESCRIPTION OF THE EMBODIMENTS

The present disclosure will be further described in detail below with reference to the embodiments.

According to the requirements for chemical element components, mass percentages and a production method of the present disclosure, five embodiments are set, namely embodiment 1, embodiment 2, embodiment 3, embodiment 4 and embodiment 5. In order to verify the influence of the chemical components and the mass percentage content as well as the cast billet heating temperature, the finishing temperature and the tempering temperature after finish rolling in the rolling process on performance parameters, three comparative examples, namely comparative example 1, comparative example 2 and comparative example 3, are prepared, and eight batches of steel plates are smelted and rolled.

The mass percentage content of the chemical components of comparative example 1 is not within the scope of the present disclosure, and technological parameters of a preparation process are within the scope of the present disclosure; the mass percentage content of the chemical components of comparative example 2 is within the scope of the present disclosure, and technological parameters of a preparation process are not within the scope of the present disclosure; and the mass percentage content of the chemical components and technological parameters of a preparation process of comparative example 3 are both not within the scope of the present disclosure. The mass percentages of the chemical element components of the five embodiments and the three comparative examples are shown in Table 1, with the balance being Fe and unavoidable impurities.

TABLE 1
Chemical component comparison (wt. %) of embodiments
and comparative examples of present disclosure

| | Embodiment of present disclosure | | | | | Comparative example | | |
|---|---|---|---|---|---|---|---|---|
| Element | 1 | 2 | 3 | 4 | 5 | 1 | 2 | 3 |
| C | 0.21 | 0.18 | 0.22 | 0.24 | 0.19 | 0.67 | 0.23 | 0.14 |
| Si | 0.16 | 0.14 | 0.10 | 0.19 | 0.172 | 0.27 | 0.11 | 0.31 |
| Mn | 18.5 | 16.1 | 17.1 | 17.8 | 18.9 | 6.86 | 17.13 | 1.45 |
| P | 0.011 | 0.009 | 0.012 | 0.011 | 0.01 | 0.016 | 0.011 | 0.018 |
| Mo | 0.26 | 0.15 | 0.18 | 0.35 | 0.31 | 0.032 | 0.17 | 0.02 |
| RE | 0.12 | 0.21 | 0.10 | 0.25 | 0.19 | 0.0031 | 0.13 | 0.0022 |

Production process control parameters and steel plate quality conditions are shown in

TABLE 2
Table 2 Table of production process control vs. steel plate performance
conditions of embodiments of present disclosure and comparative examples

| | | Cast billet | | | | Impact |
|---|---|---|---|---|---|---|
| | | heating | Finishing | Tempering | Yield | energy |
| Serial number of | | temperature | temperature | temperature | strength | at −150° C. |
| steel | | (° C.) | (° C.) | (° C.) | (MPa) | (J) |
| Embodiment | 1 | 1167 | 1023 | 307 | 427 | 116 |
| of present | | | | | | |
| disclosure | | | | | | |
| Embodiment | 2 | 1200 | 991 | 316 | 410 | 128 |
| of present | | | | | | |
| disclosure | | | | | | |
| Embodiment | 3 | 1160 | 980 | 320 | 439 | 66 |
| of present | | | | | | |
| disclosure | | | | | | |
| Embodiment | 4 | 1176 | 989 | 297 | 431 | 98 |
| of present | | | | | | |
| disclosure | | | | | | |
| Embodiment | 5 | 1185 | 1012 | 280 | 442 | 188 |
| of present | | | | | | |
| disclosure | | | | | | |
| Embodiment | | | | | | |
| of present | | | | | | |
| disclosure | | | | | | |
| Comparative | 1 | 1182 | 993 | 319 | 316 | 16 |
| steel | | | | | | |
| Comparative | 2 | 1268 | 831 | 457 | 391 | 21 |
| steel | | | | | | |
| Comparative | 3 | 1245 | 902 | 655 | 345 | 34 |
| steel | | | | | | |

As can be seen from Table 1 and Table 2, the steel plates produced according to the chemical components and the mass percentages as well as the rolling temperature controlled in the production process of embodiments 1-5 of the present disclosure have the yield strength of higher than 410 MPa, while the comparative steel plates produced according to the steel component ranges or/and the production processes which are not within the range of the present disclosure of comparative example 1, comparative example 2 and comparative example 3 have the yield strength of lower than 316 MPa.

The steel plate prepared in embodiment 5 has the yield strength of 442 MPa, impact energy at −150° C. of 188 J, and an excellent comprehensive mechanical property, such that embrittlement cracking may be effectively avoided for when the steel plate is used for manufacturing ultralow-temperature structural parts, safe operation is achieved, and embodiment 5 is the best embodiment.

What is claimed is:

1. A nickel-free LPG marine steel plate, comprising the following chemical components in percentage by mass: C: 0.18-0.24%, Si: 0.10-0.19%, Mn: 16.1-18.9%, P: 0.012%, Mo: 0.15-0.35%, RE: 0.10-0.25%, and the balance Fe and inevitable impurities.

2. The nickel-free LPG marine steel plate according to claim 1, wherein a metallographic structure is a single-phase austenite structure.

3. The nickel-free LPG marine steel plate according to claim 1, wherein in the chemical components in percentage by mass, Mn is 17.1-18.9%.

4. The nickel-free LPG marine steel plate according to claim 1, wherein in the chemical components in percentage by mass, Mo is 0.25-0.35%.

5. A manufacturing method for the nickel-free LPG marine steel plate according to claim 1, comprising processes of electric furnace smelting, vacuum degassing (VD) furnace refining, die casting, rolling, cooling after rolling and tempering,
wherein in the rolling process, a 160 mm*1000 mm*2200 mm die casting plate billet is immediately rolled after being uniformly heated and discharged from a furnace, an initial rolling temperature 1100° C., and a finishing temperature 980° C.;
in the process of cooling after rolling, the steel plate is rapidly cooled to a room temperature by means of watering; and
in the tempering process, the steel plate is tempered at 280-320° C., and heat preservation is conducted for 80-120 min.

6. The manufacturing method according to claim 5, wherein in the electric furnace smelting process, an alloy comprising CaO, scrap steel, MnFe, SiFe and MoFe is charged for electric melting, FeO is added to remove P, and a content of alloying elements is adjusted to a target value.

7. The manufacturing method according to claim 5, wherein in the VD furnace refining process, gas elements comprising O, N and H are removed in vacuum.

8. The manufacturing method according to claim 5, wherein in the die casting process, rare earth wires are fed during casting, and a content of a rare earth element reaches a target value.
